(19) United States
(12) Patent Application Publication
(10) Pub. No.: US 2016/0235181 A1
(43) Pub. Date: Aug. 18, 2016

(54) SYSTEM FOR CLEANING A SHAVING UNIT

(71) Applicant: KONINKLIJKE PHILIPS N.V., Eindhoven (NL)

(72) Inventors: HENDRIK KLAAS LOUWSMA, EINDHOVEN (NL); ESTHER VREDEVELD, EINDHOVEN (NL); SIETZE ALGRA, EINDHOVEN (NL); RENGER YPENBURG, EINDHOVEN (NL)

(21) Appl. No.: 15/025,579

(22) PCT Filed: Sep. 22, 2014
(86) PCT No.: PCT/EP2014/070074

§ 371 Date: Mar. 29, 2016

(30) Foreign Application Priority Data
Sep. 30, 2013 (EP) 13186652.7

(51) Int. Cl. A45D 27/46; B08B 3/10; B08B 3/14

(52) U.S. Cl. CPC A45D 27/46; B08B 3/14; B08B 3/102

(57) ABSTRACT

A system comprises a first container (2) holding liquid (9) and a second container (4) holding a shaving unit (1) in the liquid (9). A pump (3) pumps the liquid (9) from the first container (2) into the second container (4). A drain (5) enables the liquid (9) to flow from the second container (4) back to the first container (2). A pump driver (6) supplies power to the pump (3) during active periods (Ta) of a cleaning cycle (Tt). A sensor (7) senses the power. A controller (8) detects a disruption in the flow of the liquid (9) by detecting that sensed information (Ab) deviates more than a threshold value (At) from nominal information (An). The nominal sensed information (An) occurs when there is no disruption in the flow of the liquid (9) through the pump (3) during the active periods (Ta).The threshold value (At) is in a range of 0.05 to 0.25 times a nominal value of the current (I) or a nominal value of the voltage (V) supplied to the pump (3) occurring when there is no disruption of the nominal flow of the liquid (9) through the pump (3) during the active periods (Ta).

### FIELD OF THE INVENTION

The invention relates to a system for pumping cleaning liquid along a shaving unit, a cleaning device for cleaning the shaving unit comprising the system for pumping, a shaver cleaning system comprising the cleaning device and the shaving unit, and a method of cleaning a shaving unit by pumping a cleaning liquid along the shaving unit.

### BACKGROUND OF THE INVENTION

JP2010069030A discloses an electric shaver washer. The shaver is inserted into a washing tank. The washing water is stored in a storage tank. A pump mechanism, which comprises an electric pump motor, pumps the washing water from the storage tank into the washing tank. A drainage pipe enables the washing water to flow back from the washing tank to the storage tank. The current through the electric pump motor is sensed to detect a failure of parts. If a failure is detected, a failure warning is indicated by means of a LED.

### SUMMARY OF THE INVENTION

It is an object of the invention to provide a warning to the user of the cleaning system when the cleaning liquid has reached end of life and should be replaced.

A first aspect of the invention provides a system for pumping cleaning liquid along a shaving unit as claimed in claim 1. A second aspect of the invention provides a cleaning device which comprises the system for pumping. A third aspect of the invention provides a shaver cleaning system including the shaving unit. A fourth aspect of the invention provides a method of cleaning a shaving unit. Advantageous embodiments are defined in the dependent claims.

The system for pumping cleaning liquid along a shaving unit comprises a first container which holds the cleaning liquid and a second container. The shaving unit may be held in the cleaning liquid in either the first container or the second container. The shaving unit may be the complete shaver or may be a portion of the shaver, for example only the shaving head. A pumping mechanism pumps the cleaning liquid from the first container into the second container. A drain is arranged between the second container and the first container such that the cleaning liquid can flow from the second container back to the first container under gravity. A pump driver supplies power to the pumping mechanism during active periods of a cleaning cycle wherein the cleaning liquid is pumped by the pumping mechanism from the first container to the second container. A sensor senses the current or the voltage supplied by the pump driver to the pumping mechanism to obtain sensed information. A controller is configured to receive the sensed information and to detect a disruption of the flow of the cleaning liquid through the pumping mechanism. Such a disruption is detected when the sensed information deviates more than a threshold value from nominal information. The nominal information corresponds to a value of the sensed information (Si) occurring when there is no disruption of the flow of the cleaning liquid through the pumping mechanism during the active periods. The threshold value is in a range of 0.05 to 0.25 times a nominal value of the current or a nominal value of the voltage occurring when there is no disruption of the nominal flow of the cleaning liquid through the pumping mechanism during the active periods. By disruption of the flow of the liquid may be meant that not only liquid but a mixture of liquid and air, or even no liquid at all but only air, is pumped. The sensor senses the nominal information, i.e. the nominal level or value of the current supplied to the pumping mechanism, and/or the nominal level or value of the voltage supplied to the pumping mechanism, when a nominal flow of the cleaning liquid occurs from the first container to the second container during the active periods of the cleaning cycle.

Thus, the controller may detect during a pumping action whether the current to the pumping mechanism drops such that the actual level of the current during the drop is at least the threshold value lower than the nominal level of the current. Such a drop will be detected if the level of the liquid in the first container drops so far that the pumping mechanism starts pumping a mixture of liquid and air or even only air, and thus if the normal flow of the liquid is disrupted. The lower current drawn by the pumping mechanism is caused by the fact that the torque to be exerted by the pumping mechanism will drop if not only liquid has to be pumped.

Hereinafter, the pumping mechanism may also be referred to as the pump and the cleaning liquid may also be referred to as the liquid. The pump may be any pump suitable for pumping liquid and may comprise an electric motor driving a paddle wheel or rotor fan.

In an embodiment, the drop of the current through the pump may be caused by a partially or fully clogged filter due to dirt washed off from the shaving unit. The dirt presents an obstruction to the flow of the liquid into the pump. The filter may be arranged between the drain and the pump, thus outside the pump housing, or at the liquid inlet of the pump or both. In all these embodiments, when the filter or filters get too dirty, the amount of liquid which enters the pump will be smaller than the nominal amount the pump is able to transport and a drop in the current to be supplied to the pump will occur. The embodiment wherein the one or more filters are outside the pump housing has the advantage that the filter or filters are easier to replace, especially if the filter or filters are part of a replaceable cartridge. Additionally, or instead of accumulation of dirt on the filter, the level drop may be caused by evaporation of the liquid which adheres to the shaving unit.

Although usually the pump is driven at a voltage which has an (almost) constant amplitude (such as the mains) and consequently a lower load on the pump causes a drop of the current, if the pump is driven at an (almost) constant current, the drop will occur in the voltage.

In an embodiment, the detection of the disrupted flow of the liquid is used to indicate to the user that the liquid level is too low or the cartridge has reached its end of life. In such an embodiment, the system comprises an indicator driven by the controller and configured to indicate an insufficient level of the cleaning liquid in the first container. In an embodiment wherein the first container is a replaceable cartridge, the detection of the lower current is used to indicate that the replaceable cartridge has reached its end of life and has to be replaced by a new cartridge by the user. In such an embodiment, the system comprises an indicator driven by the controller and configured to indicate a required replacement of the replaceable cartridge. In an embodiment, the new cartridge comprises both clean liquid and one or more clean filters. The use of such a cartridge obviates the difficult replacement of the dirty filter or the difficult exchange of dirt and liquid.

Many algorithms may be applied to the detected drop of the current supplied to the pump when it has to be decided whether or not the indication that the cartridge has to be exchanged has to be given to the user. For example, the number of drops of the current, or the duration of the drop or drops, or a cumulative duration of a plurality of drops, or any combination thereof, during a cleaning period or during an active period of the pump during any one of the sub-periods of the cleaning period (the wetting, hair removal, deep cleaning, rinsing and dripping periods) may be decisive. Additionally, the rate of change of the level of successive drops may be considered.

In an embodiment, the indication to the user that the cartridge has to be exchanged may be given if more than three drops, each one longer than 1 second, occur during a same cleaning period. In another embodiment, the indication is given after a second drop which is at least 25% longer than the preceding drop (2 seconds followed by 2.5). In another embodiment, only the drops during the rinsing phase are checked to decide whether it should be indicated to the user that the cartridge has to be replaced. For example, two drops, each shorter than 1 second, will not lead to the indication, while two drops, each longer than 2 seconds, will lead to the indication.

The nominal level of the current to the pump may vary over time, for example over the lifetime of the pump or over the lifetime of a cartridge. To correct for these variations, in an embodiment, the nominal value of the current is sensed regularly during cleaning cycles. In an embodiment, the latest sensed value or an average value of the latest sensed values is used as the nominal current value to check whether the actual current deviates more than the threshold value.

Instead of sensing the current supplied to the pump, dependent on the pump construction and its drive, it may be possible to detect the disruption of the flow of the cleaning liquid through the pump by sensing the voltage across the pump.

These and other aspects of the invention are apparent from and will be elucidated with reference to the embodiments described hereinafter.

### BRIEF DESCRIPTION OF THE DRAWINGS

In the drawings:

FIG. 1 shows schematically a cleaning system for a shaving unit in accordance with an embodiment of the invention,

FIG. 2 shows schematically a cross-section of a replaceable cartridge,

FIG. 3 shows schematically a block diagram of a pump controller in the system for pumping cleaning liquid along the shaving unit,

FIG. 4 shows the phases in a cleaning cycle,

FIG. 5 shows the current through the pump during a portion of the cleaning cycle, and

FIG. 6 shows schematically an alternative embodiment of the cleaning system for the shaving unit.

### DETAILED DESCRIPTION OF THE PREFERRED EMBODIMENT

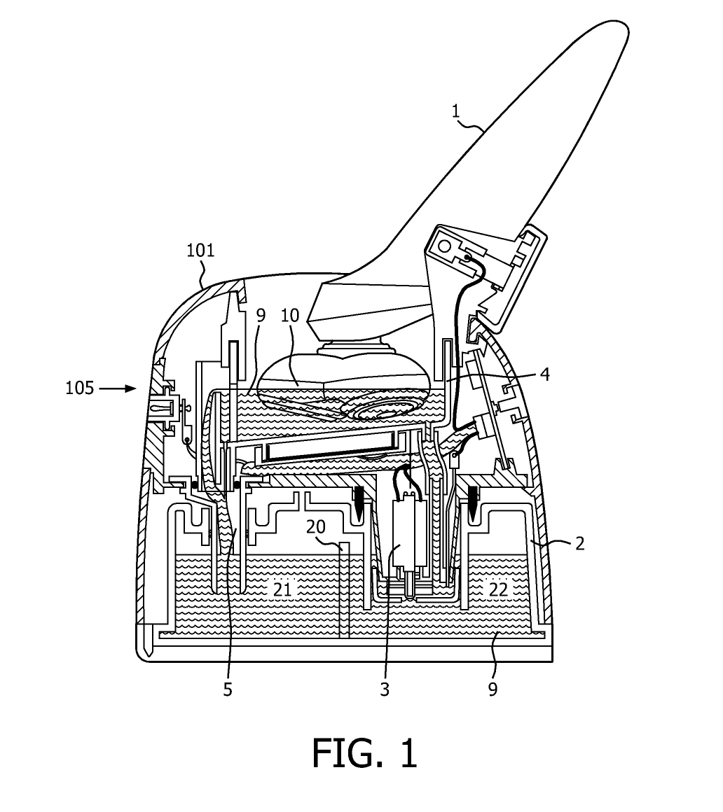

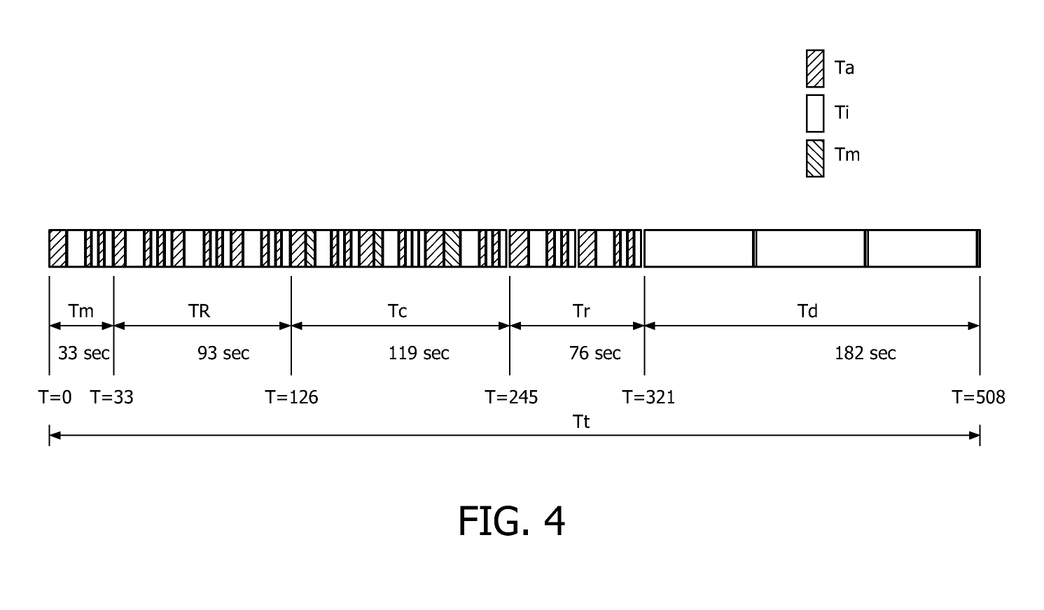

FIG. 1 shows schematically a cleaning system for a shaving unit in accordance with an embodiment of the invention. The cleaning system comprises the cleaning device 105 and the shaver 1. The shaving unit is the portion of the shaver 1 which should be cleaned and which is held in the cleaning liquid by the cleaning device 105. In this embodiment, the shaving unit is the shaving head 10 inside the container 4. The container 4 is also referred to as the cradle 4. The cleaning device 105 further comprises the container 2 which contains the cleaning liquid 9 and the filter 20. In the embodiment shown in FIG. 1, the container 2 is an exchangeable cartridge 2 which has a compartment 21 to the left of the vertical filter 20 and a compartment 22 to the right of the filter 20. During active periods (Ta, see FIG. 4), the pumping mechanism 3 pumps the cleaning liquid 9 out of the compartment 22 into the cradle 4. A drain 5 between the cradle 4 and the compartment 21 enables the cleaning liquid 9 to flow back under gravity from the cradle 4 into the drain compartment 21 of the cartridge 2. The vertically arranged filter 20 prevents hairs and other debris from entering the pump compartment 22. The cartridge 2 may have suitable ribs and/or one or more perforated dividing walls to keep the filter material of the filter 20 in position. An additional filter (not shown) may be present in front of the liquid inlet of the pump (3).

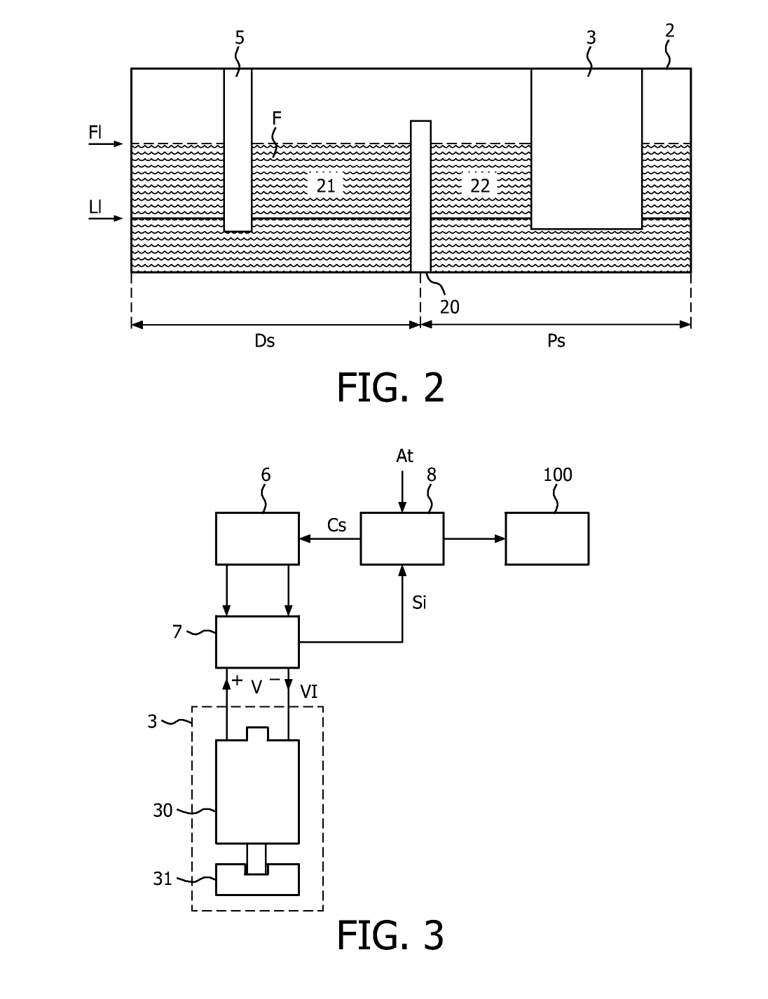

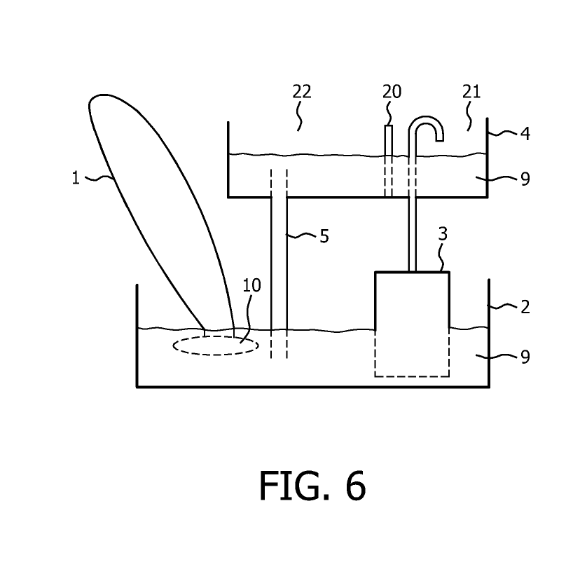

A schematically represented cross section of the cartridge 2 is elucidated with reference to FIG. 2. The operation of the cleaning system for a shaving unit will be elucidated with reference to FIGS. 3 to 5. An alternative embodiment of the cleaning system is discussed with reference to FIG. 6.

FIG. 2 shows schematically a cross-section of the replaceable cartridge. The cartridge 2 comprises the drain compartment 21 which is separated from the pump compartment 22 by a vertical filter 20. The drain tube 5 opens into the drain compartment 21 and the inlet of the pumping mechanism 3 (further also referred to as “ pump”) is arranged inside the pump compartment 22. The inlet is near the bottom of the cartridge 2 to enable the pump to suck up the cleaning liquid 9 even when the level of the liquid is low. The dashed level F1 indicates the level of the cleaning liquid 9 of a new cartridge. In FIG. 2, the cartridge 2 has been used for some time such that the level of the cleaning liquid 9 has dropped to the low level L1. The pump 3 is still able to pump the cleaning liquid 9 without mixing air into the cradle 4. However, if the level of the cleaning liquid 9 drops even further, the pump 3 will not be able to pump only the cleaning liquid 9 and will also suck in air. Now, due to the lower load on the pump 3, the current I (see FIG. 3) drawn by the pump 3 will decrease.

It has to be noted that the pump is part of the cleaning device, not of the cartridge.

Although in FIG. 2 the level of the cleaning liquid 9 is the same in both the drain compartment 21 and the pump compartment 22, when the pump 3 is active, the level in the pump compartment 22 may become lower than the level in the drain compartment 21 because of the resistance caused by the vertical filter 20, especially if dirt has accumulated in the filter 20. Or, phrased differently, insufficient cleaning liquid 9 passes the dirty vertical filter 20 to keep up with the amount of cleaning liquid 9 pumped out of the pump compartment 22. Consequently, after an initial period wherein there is still sufficient cleaning liquid 9 in the pump compartment 22, the pump 3 will start to suck in air. The resultant lower load on the pump 3 can be detected through a drop of the current I drawn or of the voltage V across the pump 3. In the same manner, if too much cleaning liquid 9 has evaporated after a plurality of cleaning cycles Tt, the level of the cleaning liquid 9 may drop so far that the pump 3 starts to suck in air. Independent of what caused the too low level of the cleaning liquid 9 in the pump compartment 22, the detected lower load can be used to indicate to the user that the cartridge 2 has to be exchanged for a new one.

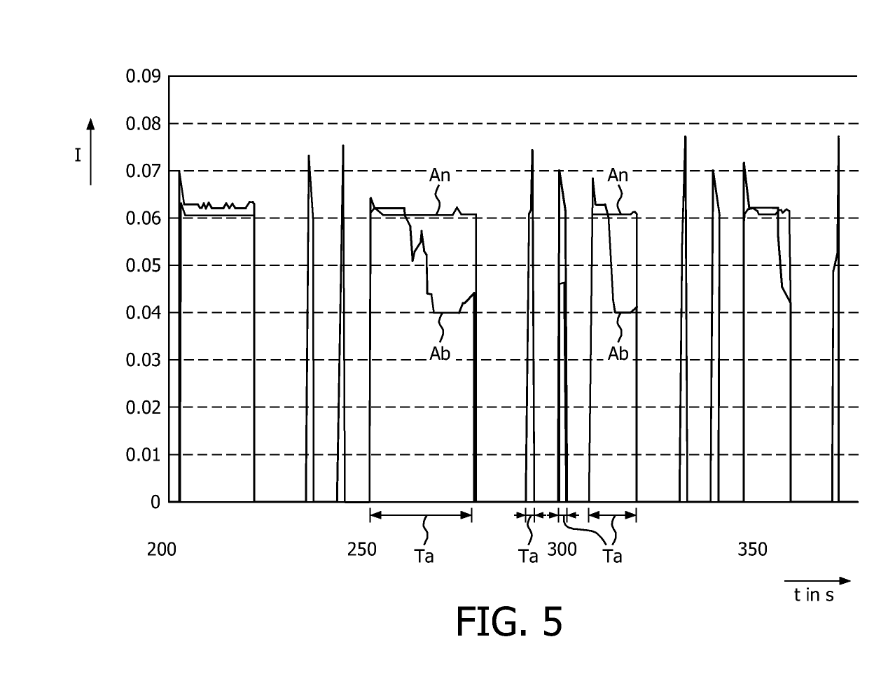

FIG. 3 shows schematically a block diagram of a pump controller in the system for pumping cleaning liquid along a shaving unit; FIG. 4 shows the phases in a cleaning cycle and FIG. 5 shows the current drawn by the pump as a function of time. The cleaning cycles of FIG. 4 and the current will be elucidated first to facilitate the elucidation of the block diagram of FIG. 3.

In the embodiment shown in FIG. 4, the cleaning cycle Tt comprises a wetting period Tw, a hair removal period Th, a deep-clean period Tc, a rinse period Tr and a drip out period Td. By way of example only, in FIG. 4 possible durations of these periods are shown.

These periods may also be referred to as sub-periods of the cleaning cycle Tt. As indicated in the legend to FIG. 4, the light gray areas indicate the active periods Ta during which the pump 3 is pumping, the dark gray areas indicate motor periods Tm during which the motor of the shaver is active, and the white areas indicate emptying periods Ti during which the cleaning liquid 9 leaves the cradle 4.

During the wetting period Tw, the pump 3 is activated during at least one active period Ta to wet the shaving unit 1 (the part of the shaver which is cleaned) present in the cradle 4. During the hair removal period Th, the pump 3 is activated during a first plurality of active periods Ta. The shaving unit 1 is activated during part of the active periods Ta when the cradle 4 is filled with the cleaning liquid 9. During the deep clean period Tc, the pump 3 is activated during a second plurality of active periods Ta and the shaving unit 1 is activated during part of the active periods Ta when the cradle 4 is filled with the cleaning liquid 9. During both the hair removal period Th and the deep clean period Tc, the shaving unit may be activated only during less than the latter half of the active periods. During the rinse period Tr, the pump 3 is activated during at least one active period Ta while the shaving unit 1 is not activated. During the drip out period Td, the pump 3 remains in the off state to empty the cradle 4 and keep it free of the cleaning liquid 9, and the shaving unit 1 is activated at least once.

The algorithm may further comprise an active drying period (not shown) during which the shaver unit is dried. Said drying may be achieved by inductive heating of the metal parts of the shaver head.

FIG. 5 shows the current through the pump during a part of the cleaning cycle. The current values in Ampere plotted on the vertical axis are valid for a particular implementation and are given by way of example only. The nominal level An of the sensed current I drawn by the pump 3 occurs as long as the pump 3 is only pumping the cleaning liquid 9 and does not suck in any air. The actual level Ab of the sensed current I is equal to the nominal level An as long as the flow of the cleaning liquid 9 into the pump 3 is not disrupted by air being sucked into the pump 3. As soon as the pump 3 starts sucking in a mixture of cleaning liquid 9 and air, the actual level Ab drops below the nominal level An, which in this example happens during the active period Ta which starts at 250 seconds and the active period Ta which starts somewhat later than 300 seconds. As said earlier, such a drop of the actual level Ab during the active period Ta may be caused by the filter 20 which has become too dirty, or because too much cleaning liquid 9 has evaporated, or both. By way of example only, in this embodiment the ratio between the actual level Ab during a drop of the current I through the motor 30 of pump 3 and the nominal level An is 40/60 and a threshold value in the range of 0.05 to 0.25 would reliably detect the current drop.

Now referring back to FIG. 3, the controller 8 supplies a control signal Cs to control the pump driver 6 which drives the pump 3 by supplying a voltage V and a current I. A sensor 7 is arranged between the pump driver 6 and the pump 3 to sense the voltage V or the current I. The sensed voltage V or the sensed current I are supplied to the controller 8 as the sensed information Si. If the sensed information Si represents the current I supplied to the pump 3, the sensor 7 may be any suitable current sensor. For example, the sensor 7 may be a resistor (not shown) electrically arranged in series with the motor 30, and the sensed information Si is, or is proportional to, a voltage drop across the resistor. The controller 8 receives, or has stored, a threshold value At and controls an indicator 100 when it is detected that the actual value of the sensed information Si differs more that the threshold value At from the nominal value of the information Si. For example, if the sensed information Si is the current I drawn by the motor 30 of the pump 3, the indication to replace the cartridge 2 is given when it is detected that the actual level Ab of the current I supplied to the motor 30 becomes lower than the nominal level An of the current I supplied to the motor 3 minus the threshold value At.

The nominal level An of the current I drawn by the pump 3 occurs during active periods Ta in which the flow of the cleaning liquid 9 to the pump 3 is not disrupted, which means that the pump 3 only pumps the cleaning liquid 9 and does not suck in any air. The nominal level An of the current Ito the pump 3 may vary over time, for example over the lifetime of the pump 3 or over the lifetime of a cartridge 2. To correct for these variations, the nominal level An of the current I may be sensed regularly during cleaning cycles Tt. For example, the nominal level An of the current I may be sensed every cleaning cycle Tt or even every sub-period of the cleaning cycle Tt. Alternatively, the nominal level An may be sensed once every particular number of cleaning cycles Tt and may be stored for use in a subsequent cleaning cycle Tt. The latest sensed level or an average value of the latest sensed levels may be used as the nominal current value An in determining the ratio between the actual current value Ab and the nominal current value An.

When deciding whether or not the indication that the cartridge has to be exchanged has to be given to the user, the controller 8 may apply any of many algorithms to the detected drop of the current I supplied to the pump 3. For example, the number of drops, or the duration of the drop or drops, or a cumulative duration of a plurality of drops, or any combination thereof during a cleaning period Tt or during an active period Ta of the pump 3 during any one of the sub-periods (the wetting, hair removal, deep cleaning, rinsing and dripping periods) of the cleaning period Tt may be decisive. Additionally, the rate of change of the level of successive drops may be considered. In an embodiment, the drops during the rinse phase are neglected in deciding whether the indication to replace the cartridge should be given. During the rinse phase, the shaving unit 1 has already been cleaned and the liquid will have sufficient time to dissolve the debris before the next cleaning will take place after use of the shaving unit 1 by the user.

In an embodiment, the indication to the user to exchange the cartridge 2 may be given if more than two drops in current, each one longer than 1 second, occur during a same cleaning period Tt, and no replacement trigger will be given if only one drop in current occurs during this same cleaning period Tt. In another embodiment, the indication is given after a second drop which is at least 25% longer than the preceding drop (2 seconds followed by 2.5). In another embodiment, only the drops during the rinse phase Tr are checked to decide whether or not it should be indicated to the user that the cartridge 2 has to be replaced. For example, two drops during the rinse phase Tr, each shorter than 1 second, will not lead to the indication, while two drops during the rinse phase Tr, each longer than 1.5 seconds, will lead to said indication or replacement trigger.

Although in FIG. 3 the pump or pump mechanism 3 comprises an electric motor 30 which drives a paddle wheel or turbine 31, any other electrically driven liquid pump may be used. The container 2 does not necessarily have to be a cartridge which is replaceable by a new one. Although such a replaceable cartridge 2 is very handy, the cartridge 2 may be constructed such that the user is able to clean it himself by replacing the dirty cleaning liquid 9 by fresh liquid and, if required, by replacing the vertical filter 20 by a new one.

During every cleaning cycle Tt some cleaning liquid 9 is lost, mainly due to evaporation at the shaver unit 1 during the drip out period Td, and especially during the active drying period. By way of example, in a particular embodiment it was found that about two to four milliliters of the cleaning liquid evaporates during each cleaning cycle Tt.

FIG. 6 shows schematically an alternative embodiment of the cleaning system for a shaving unit. Now the first container 2 accommodates the shaving unit 1 such that at least the shaving head 10 is immersed in the cleaning liquid 9. The pump 3 pumps the cleaning liquid 9 out of the container 2 into a first compartment 21 of the container 4, which may be a replaceable cartridge. The first compartment 21 is separated from the second compartment 22 of the container 4 by a vertical filter 20. A drain 5 enables the cleaning liquid 9 to flow back from the container 4 into the container 2.

If the filter 20 gets too dirty or when too much cleaning liquid 9 has evaporated, insufficient cleaning liquid 9 per time unit will flow back into container 2 and the pump 3 will start pumping a mixture of cleaning liquid 9 and air. Again, the resultant drop in the current I drawn by the pump 3 can be used in an algorithm to decide when it should be indicated to the user that the container 4 has to be cleaned and the vertical filter 20 has to be cleaned or replaced, or that the cartridge 4 has to be replaced. The algorithm to decide when a warning should be given to the user that the cartridge has to be replaced or cleaned may be the same as that discussed hereinabove.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

To conclude, in an embodiment, the invention provides a system for pumping cleaning liquid 9 along a shaving unit 1. The system comprises a first container 2 holding the liquid 9 and a second container 4 which holds the shaving unit 1 in the liquid 9 when the second container is filled with the liquid 9. A pumping mechanism 3 pumps the liquid 9 from the first container 2 into the second container 4. A drain 5 enables the liquid 9 to flow from the second container 4 back to the first container 2. A pump driver 6 supplies a voltage V and a current Ito the pumping mechanism 3 during active periods Ta of a cleaning cycle Tt to achieve a nominal flow of the liquid 9 from the first container 2 to the second container 4 during the active periods Ta. A sensor 7 senses the current I or the voltage V supplied by the pump driver 6 to the pumping mechanism 3 to obtain sensed information Si. A controller 8 receives the sensed information Si and detects a disruption of the flow of the liquid 9 through the pumping mechanism 3. A detection of such a disruption occurs when it is detected that the sensed information Ab deviates more than a threshold value At from nominal information An. The nominal information An corresponds to a value or level of the sensed information Ab occurring when there is no disruption of the flow of the liquid 9 through the pumping mechanism 3 during the active periods Ta, i.e. when the flow of the liquid 9 through the pumping mechanism 3 corresponds to the nominal flow. The threshold value At is in a range of 0.05 to 0.25 times a nominal value of the current I or a nominal value of the voltage V occurring when there is no disruption of the nominal flow of the liquid 9 through the pumping mechanism 3 during the active periods Ta.

Or, put more briefly, the system comprises a first container 2 holding liquid 9 and a second container 4 holding a shaving unit 1 in the liquid 9. A pump 3 pumps the liquid 9 from the first container 2 into the second container 4. A drain 5 enables the liquid 9 to flow from the second container 4 back to the first container 2. A pump driver 6 supplies power to the pump 3 during active periods Ta of a cleaning cycle Tt. A sensor 7 senses the power. A controller 8 detects a disruption of the flow of the liquid 9 by detecting that sensed information Ab deviates more than a threshold value At from nominal information An. The nominal information An corresponds to a value of the sensed information Ab occurring when there is no disruption of the flow of the liquid 9 through the pump 3 during the active periods Ta. The threshold value At is in a range of 0.05 to 0.25 times a nominal value of the power occurring when there is no disruption of the flow of the liquid 9 through the pump during the active periods Ta.

1. A system for pumping cleaning liquid along a shaving unit, the system comprising:
a first container holding the cleaning liquid,
a second container,
the first container or the second container being arranged for holding the shaving unit in the cleaning liquid when present,
a pumping mechanism for pumping the cleaning liquid from the first container into the second container,
a drain arranged for enabling a flow of the cleaning liquid from the second container to the first container,
a pump driver for supplying a voltage (V) and a current (I) to the pumping mechanism to achieve a nominal flow of the cleaning liquid from the first container to the second container during active periods (Ta) of a cleaning cycle (Tt),
a sensor for sensing the current (I) or the voltage (V) supplied by the pump driver to the pumping mechanism to obtain sensed information (Si), and
a controller configured to receive the sensed information (Si) and to detect a disruption of the nominal flow of the cleaning liquid through the pumping mechanism during the active periods (Ta), by detecting that the sensed information (Ab) deviates more than a threshold value (At) from nominal information (An), the nominal information (An) corresponding to a value of the sensed information (Si) occurring when there is no disruption of the nominal flow of the cleaning liquid through the pumping mechanism during the active periods (Ta),
wherein the threshold value (At) is in a range of 0.05 to 0.25 times a nominal value of the current (I) or a nominal value of the voltage (V) supplied to the pumping mechanism occurring when there is no disruption of the nominal flow of the cleaning liquid through the pumping mechanism during the active periods (Ta)
wherein the system further comprises an indicator configured to indicate an insufficient level of cleaning liquid in the first container, and wherein the controller is configured for driving the indicator to indicate a warning to the user in response to a detected disruption.

2. (canceled)

3. The system as claimed in claim 1, wherein the controller is configured for driving the indicator to indicate a warning to the user in response to at least three detected disruptions in a same cleaning cycle (Tt) or in the same active period (Ta).

4. The system as claimed in claim 3, wherein the controller is configured for driving the indicator to indicate the warning to the user in response to an occurrence of said at least three detected disruptions, wherein each detected disruption has a duration longer than 1 second.

5. (canceled)

6. The system as claimed in claim 1, wherein the second container is arranged for holding the shaving unit and wherein the system further comprises a housing for holding the first container and the second container, wherein, in use, the second container is positioned on a higher level than the first container.

7. The system as claimed in claim 6, wherein the first container is a replaceable cartridge and wherein the housing is constructed for removably holding the replaceable cartridge.

8. The system as claimed in claim 1, wherein the first container has a first compartment and a second compartment being separated by a filter the first compartment being arranged for receiving the cleaning liquid from the second container via the drain, and the pumping mechanism being arranged for pumping the cleaning liquid out of the second compartment into the second container.

9. The system as claimed in claim 7, wherein the indicator is configured to indicate a required replacement of the replaceable cartridge.

10. The system as claimed in claim 8, wherein the first compartment is constructed for holding, in the cleaning liquid, debris washed off from the shaving unit.

11. The system as claimed in claim 8, wherein an additional filter (F) is arranged between the second container and the first compartment in the drain, or in the first compartment, or at a liquid inlet of the pumping mechanism.

12. The system as claimed in claim 1, wherein the cleaning cycle (Tt) comprises a wetting period (Tw) for wetting the shaving unit when, in use, it is present in the second container, a hair removal period (Th) and a deep clean period (Tc), both for removing debris from the shaving unit, a rinse period (Tr) and a drip out period (Td), and wherein the controller is constructed for:
activating, during the wetting period (Tw), the pumping mechanism during at least one active period (Ta) to wet the shaving unit when present in the second container,
activating, during the hair removal period (Th), the pumping mechanism during a first plurality of active periods (Ta) and activating the shaving unit during at least part of the active periods (Ta) when the second container is filled with the cleaning liquid,
activating, during a deep clean period (Tc), the pumping mechanism during a second plurality of active periods (Ta) and activating the shaving unit during at least part of the active periods (Ta) when the second container is filled with the cleaning liquid,
activating, during a rinse period (Tr), the pumping mechanism during at least one active period (Ta) and not activating the shaving unit,
maintaining, during a drip out period (Td), the pumping mechanism in an off state to keep the second container free of the cleaning liquid, and activating the shaving unit at least once.

13. A cleaning device for cleaning a shaving unit, comprising the system for pumping as claimed in claim 1.

14. A shaver cleaning system comprising the cleaning device of claim 13 and a shaving unit, the shaving unit comprising a shaving head, and the cleaning device being configured for holding at least the shaving head inserted into the second container, when the shaving unit is held by the cleaning device.

15. A method of cleaning a shaving unit by pumping a cleaning liquid along the shaving unit, the method comprising:
pumping the cleaning liquid by means of a pumping mechanism from a first container into a second container, the first container or the second container having a shape for holding the shaving unit, wherein the cleaning liquid flows from the second container to the first container under gravity,
controlling the pumping by supplying a voltage (V) and a current (I) to the pumping mechanism during active periods (Ta) of a cleaning cycle (Tt) to achieve a nominal flow of the cleaning liquid during the active periods (Ta),
sensing the current (I) or the voltage (V) supplied to the pumping mechanism to obtain sensed information (Si), and
detecting a disruption of the nominal flow of the cleaning liquid during the pumping by detecting that the sensed information (Ab) deviates more than a threshold value (At) from nominal information (An), the nominal information (An) corresponding to a value of the sensed information (Si) occurring when there is no disruption of the nominal flow of the cleaning liquid during the pumping in the active periods (Ta),
wherein the threshold value (At) is in a range of 0.05 to 0.25 times a nominal value of the current (I) or a nominal value of the voltage (V) supplied to the pumping mechanism occurring when there is no disruption of the nominal flow of the cleaning liquid through the pumping mechanism during the active periods (Ta), wherein the method further comprises warning a user in response to a detected disruption by indicating an insufficient level of the cleaning liquid in the first container first container.

16. The system as claimed in claim 1, wherein the first container is a replaceable cartridge, and wherein the indicator is configured to indicate a required replacement of the replaceable cartridge.
